(19) United States
(12) Patent Application Publication
(10) Pub. No.: US 2025/0157723 A1
(43) Pub. Date: May 15, 2025

(54) COIL DEVICE

(71) Applicant: TDK CORPORATION, Tokyo (JP)

(72) Inventors: Shoichi TANI, Tokyo (JP); Toshiyuki HORIKAWA, Tokyo (JP)

(73) Assignee: TDK CORPORATION, Tokyo (JP)

(21) Appl. No.: 18/930,017

(22) Filed: Oct. 29, 2024

(30) Foreign Application Priority Data
Nov. 14, 2023 (JP) 2023-193625

(51) Int. Cl. H01F 27/29; H01F 5/04; H01F 27/22

(52) U.S. Cl. CPC H01F 27/292; H01F 5/04; H01F 27/22; H01F 2005/043

(57) ABSTRACT

A coil device includes a core including a winding core portion, a winding portion of a wire disposed in a coil shape around the winding core portion, and a base plate provided with a terminal to which a leading portion of the wire led out from the winding portion is attached. The core is disposed on a first surface as one surface of the base plate. A wire connection portion of the terminal is disposed on a second surface as the other surface of the base plate located opposite to the first surface. The base plate is provided with a base-side passage for passing and guiding the leading portion of the wire from the winding portion to the wire connection portion.

### BACKGROUND OF THE DISCLOSURE

The present invention relates to a coil device used in various electronic devices.

For example, a coil device shown in Patent Document 1 is known. This coil device is configured so as to prevent an end (leading portion) of a wire wound in a coil shape from being on a base. Thus, a protrusion portion is provided on a side surface of the base, and the coil end is configured to pass from under the protrusion portion toward a terminal.

In a coil device configured in such a manner, however, since the wire is connected on the outside of the side surface of a base plate, the leading portion of the wire may be in contact with an outer peripheral edge of the base plate, the insulating coating of the leading portion of the wire may easily be damaged, and there may be insulation failure or breakage of the leading portion of the wire.
Patent Document 1: JP2010182733 (A)

### BRIEF SUMMARY OF THE INVENTION

The present invention has been made in view of the above circumstances. It is an object of the invention to provide a coil device being capable of effectively preventing insulation failure and breakage of a leading portion of a wire and being excellent in reliability.

To achieve the above object, a coil device according to an aspect of the present invention comprises:
a core including a winding core portion;
a winding portion of a wire disposed in a coil shape around the winding core portion; and
a base plate provided with a terminal to which a leading portion of the wire led out from the winding portion is attached,
wherein
the core is disposed on a first surface as one surface of the base plate,
a wire connection portion of the terminal is disposed on a second surface as the other surface of the base plate located opposite to the first surface, and
the base plate is provided with a base-side passage for passing and guiding the leading portion of the wire from the winding portion to the wire connection portion.

In the coil device according to an aspect of the present invention, since the base plate is provided with a base-side passage for passing and guiding the leading portion of the wire from the winding portion to the wire connection portion, the leading portion of the wire is less likely to be in contact with the outer peripheral edge of the base plate. Thus, the insulating coating of the leading portion of the wire is less likely to be damaged, and it is possible to effectively prevent insulation failure and breakage of the leading portion of the wire. Thus, the reliability of the coil device is improved.

Preferably, the base-side passage comprises a notched dent or a through hole penetrating the first surface and the second surface. In this configuration, when the leading portion of the wire is guided to the base plate by penetrating it via the notched dent or the through hole, the leading portion of the wire is less likely to be in contact with the outer peripheral edge of the base plate.

Preferably, an inner peripheral edge of the base-side passage extends close to the winding core portion. In this configuration, when the leading portion of the wire is guided from the winding portion disposed around the winding core portion to the wire connection portion located on the second surface of the base plate, the leading portion of the wire is more unlikely to be in contact with the outer peripheral edge of the base plate.

The core may include a flange portion magnetically coupled to the winding core portion. Preferably, the flange portion is disposed on the base plate and includes a core-side passage communicated with the base-side passage. In this configuration, the leading portion of the wire can easily be guided from the winding portion disposed around the winding core portion to the wire connection portion located on the second surface of the base plate after sequentially passing through the core-side passage and the base-side passage.

Thus, the leading portion of the wire is more unlikely to be in contact with the outer peripheral edge of the base plate and is also unlikely to be in contact with the outer peripheral edge of the flange portion of the core. As a result, the insulating coating of the leading portions of the wire is more unlikely to be damaged, and it is possible to more effectively prevent insulation failure and breakage of the leading portion of the wire. Thus, the reliability of the coil device is further improved.

The base plate may include a protrusion portion protruding from the first surface of the base plate so as to surround at least a part of the core including the flange portion. The protrusion portion can determine the position of the core with respect to the base plate and can improve the insulation between the core disposed on the first surface and the wire connection portion of the terminal disposed on the second surface.

The core-side passage may include at least a pair of core-side passages. Preferably, one and the other of the pair of core-side passages are located opposite to each other around the winding core portion. In this configuration, for example, it is possible to pass the leading portion of the wire constituting a primary coil through one of the pair of core-side passages and the leading portion of the wire constituting a secondary coil through the other of the pair of core-side passages, and terminals to which leading portions of a wire requiring a high degree of insulation are connected can easily be positioned opposite to each other around the core.

The coil device may further comprise a case for accommodating the core and the winding portion of the wire so as to cover at least the winding portion of the wire disposed around the winding core portion. Preferably, a heat dissipating resin is filled in the case up to a position where at least a part of the winding portion of the wire is immersed.

When the heat dissipating resin is filled, the coil device can be cooled effectively by efficiently transferring the heat generated in the winding core portion of the core and the winding portion of the wire via the heat dissipating resin. Also, the winding portion of the wire and the core can be effectively protected by the heat dissipating resin and the case. If the case is made of metal, the heat dissipation characteristics are further improved, but the case may be made of resin (preferably, a resin with excellent heat dissipation characteristics). In this case, the insulation characteristics are improved.

The heat dissipating resin may be filled in the case so as to cover the wire connection portion of the terminal disposed on the second surface of the base plate. In this configuration, the wire connection portion is covered with the heat dissipating resin and can thus be protected.

The terminal may include: a joint portion provided with the wire connection portion at one end; and an external connection portion formed at the other end of the joint portion. Preferably, the joint portion is fixed to a fixation protrusion portion formed to protrude from the second surface of the base plate, and a top of the fixation protrusion portion and the external connection portion of the terminal protrude from the heat dissipating resin. When the external connection portion of the terminal protrudes from the heat dissipating resin, the coil device is mounted easily.

### BRIEF DESCRIPTION OF THE SEVERAL VIEWS OF THE DRAWING

FIG. 1A is a schematic perspective view of a coil device according to an embodiment of the present invention;

FIG. 1B is a schematic perspective view of the coil device shown in FIG. 1A from another angle;

FIG. 2A is a schematic exploded perspective view of the coil device shown in FIG. 1A;

FIG. 2B is a schematic exploded perspective view of a coil device according to another embodiment of the present invention;

FIG. 3 is a schematic exploded perspective view in which terminals and a terminal block shown in FIG. 2A are further exploded;

FIG. 4 is a cross-sectional view of a main part of the coil device taken along line III-III shown in FIG. 1A;

FIG. 5 is a schematic perspective view showing a process for manufacturing the coil device shown in FIG. 1A; and

FIG. 6 is a schematic perspective view showing the relation between a lower core and the terminal block of the coil device shown in FIG. 2A.

### DETAILED DESCRIPTION OF THE INVENTION

Hereinafter, embodiments are described with reference to the figures. Note that, the contents shown in the figures are merely schematic and illustrative, and the appearance, dimensional ratio, etc. may be different from the actual one. The present invention is not limited to the following embodiments.

### First Embodiment

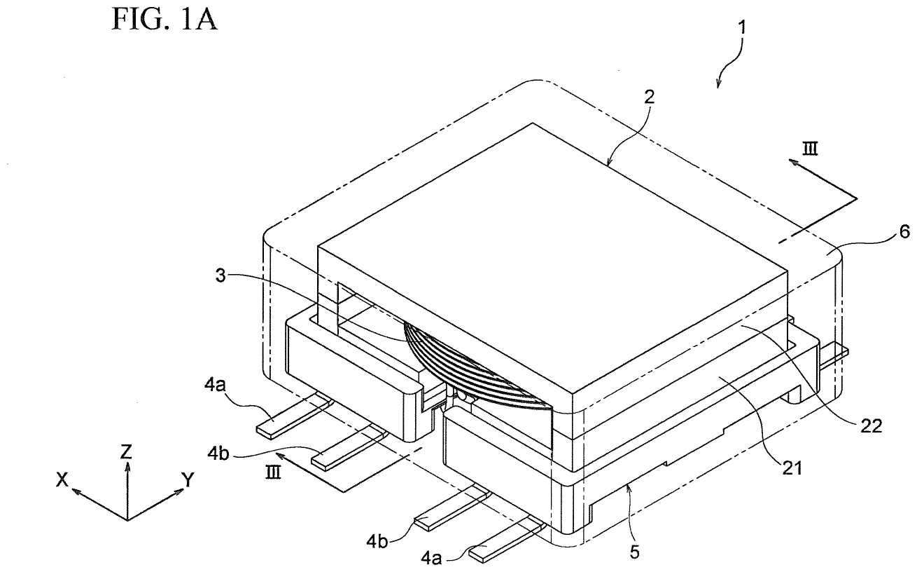

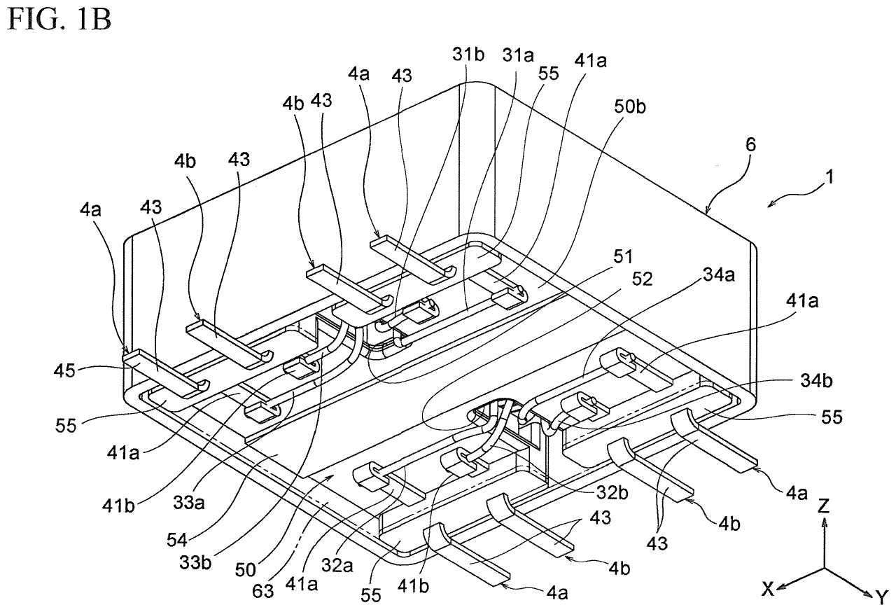

A coil device 1 according to an embodiment shown in FIG. 1A is used, for example, as a transformer and is used in power circuits for chargers and various electrical devices. The coil device 1 includes a core 2, a coil body (a winding portion of a wire) 3, terminals 4a and 4b, a terminal block 5, and a case 6. Note that, in the figures, the X-axis, the Y-axis, and the Z-axis are perpendicular to each other, and the Z-axis is parallel to the height direction of the coil device 1 (the winding axis direction of a coil). In the following description, for each of the X-axis, the Y-axis, and the Z-axis, the direction toward the center of the coil device 1 is referred to as “inside”, and the direction away from the center of the coil device 1 is referred to as “outside”.

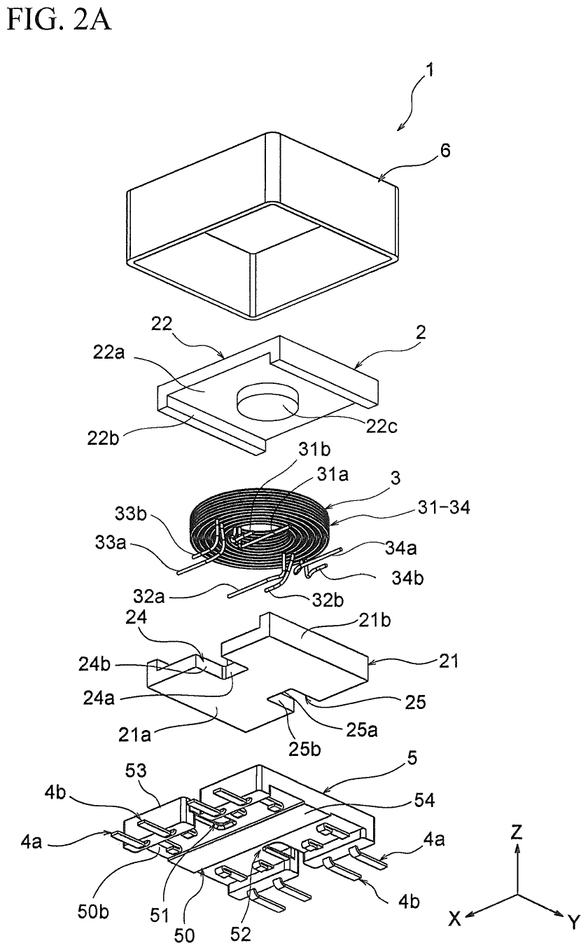

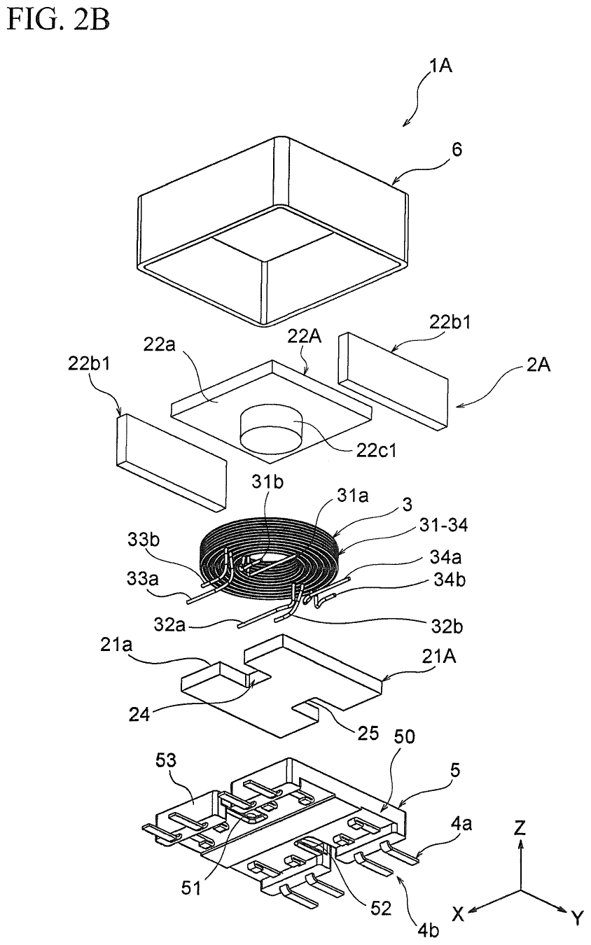

As shown in FIG. 2A, the core 2 is formed by assembling a first core 21 disposed on the lower side along the Z-axis and a second core 22 disposed above the first core 21 along the Z-axis. The first core 21 and the second core 22 are each made of an E-shaped core having a substantially E-shape in a cross section parallel to a plane including the Z-axis and the X-axis, but may be mutually different types of cores.

For example, one core may be an E-type core, and the other core may be an I-type core. In the present embodiment, the core 2 is formed by combining two divided cores 21 and 22, but is not limited to being divided into two and may be formed by combining three or four or more divided cores.

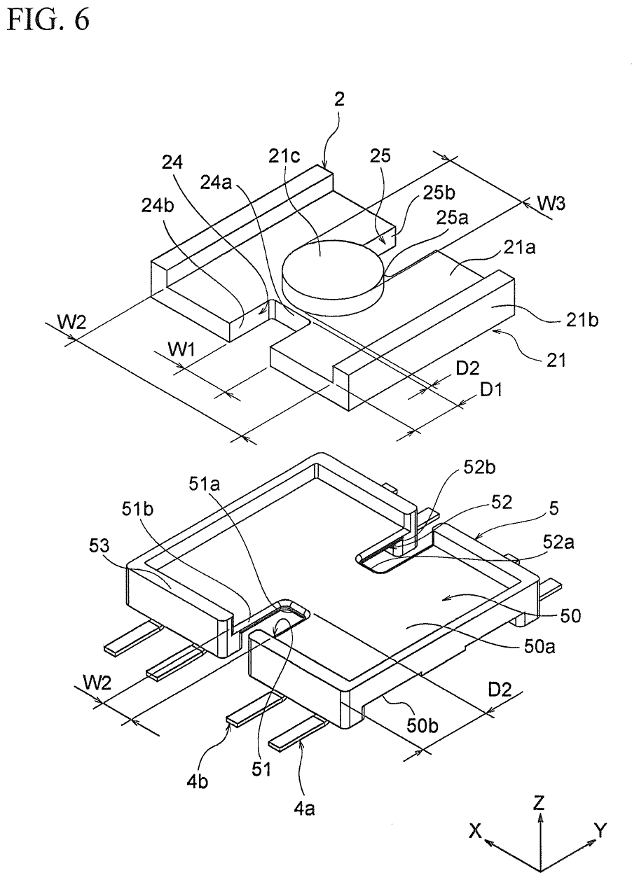

In the present embodiment, as shown in FIG. 6, the first core 21 includes: a flange portion 21a having a bottom surface parallel to a plane including the X-axis and the Y-axis; a middle leg portion (winding core section) 21c extending upward along the Z-axis from the center of the flange portion 21a; and a pair of side leg portions 21b extending upward along the Z-axis from both ends of the flange portion 21a along the X-axis.

As shown in FIG. 2A, the second core 22 includes: a flange portion 22a having an upper surface parallel to a plane including the X-axis and the Y-axis; a middle leg portion 22c extending downward along the Z-axis from the center of the flange portion 22a; and a pair of side leg portions 22b extending downward along the Z-axis from both ends of the flange portion 22a along the X-axis. Note that, in the present embodiment, the cross sections of the middle leg portions 21c and 22c perpendicular to the Z-axis are circular, but may be other shapes, such as elliptical and polygonal.

In the present embodiment, the flange portion 21a of the first core 21, which is closer to the terminal block 5 among the cores 21 and 22, is provided with a pair of a first dent 24 and a second dent 25. The second core 22 has a similar structure to the first core 21, except that the dents 24 and 25 are not formed.

As shown in FIG. 6, the first dent 24 and the second dent 25 are located on opposite sides of the middle leg portion 21c along the Y-axis and are each formed so as to be notched from the outer periphery of the flange portion 21a toward the middle leg portion 21c along the Y-axis. Each of the dents 24 and 25 penetrates the flange portion 21a so that one surface and the other surface of the flange portion 21a along the Z-axis are communicated with each other. As described below, each of the dents 24 and 25 forms a core-side passage for passing leading portions 31a to 34a and 31b to 34b of wires 31 to 34 shown in FIG. 2A.

As shown in FIG. 6, the dent 24 is formed so as to extend along the radial direction of the middle leg portion 21c toward the middle leg portion 21c. A depth D1 along the Y-axis from the opening end of the dent 24 to a dent bottom end 24a is determined so that a gap D2 between the dent bottom end 24a and the middle leg portion 21c is 0 or more. Preferably, the gap D2 is 1 mm or less. When the gap D2 is small, for example, the leading portions 31a and 31b of the wire 31 on the innermost side disposed around the middle leg portion 21c can easily pass through the dent 24, and it is possible to reduce the risk of the leading portions 31a and 31b coming into contact with the first core 21.

The distance between a pair of dent side ends 24b of the dent 24, namely, a width W1 of the dent 24 along the X-axis is, for example, smaller than a width W2 of the flange portion 21a along the X-axis excluding the side leg portions 21b and is preferably smaller than a width W3 of the middle leg portion along the X-axis. The width W1 is larger than the diameter of each of the wires 31 to 34 shown in FIG. 2A and is preferably 1.5 times or more the diameter of each of the wires 31 to 34. The width W1 and the depth D1 of the dent 24 are determined so that the wires 31 to 34 passing through the dent 24 can easily enter the dent 24 without deteriorating the magnetic characteristics of the first core 21.

Note that, the shape of the dent bottom end 24a is a flat surface in the present embodiment, but is not limited to it and may be a curved surface. The dent bottom end 24a and the dent side ends 24b are continuous to each other. Preferably, the corner edges where the ends 24a and 24b intersect with the upper surface or the lower surface of the flange portion 21a are processed into curved or tapered surfaces. In this configuration, even if the leading portions 31a, 31b, 33a, and 33b of the wires 31 and 33 passing through the dent 24 come into contact with the first core 21, it is possible to minimize the damage to the wires 31 and 33.

The shape and size of a dent bottom end 25a and dent side ends 25b of the dent 25 are determined in the same manner as those of the dent bottom end 24a and the dent side ends 24b of the dent 24 and are preferably the same as those of the dent bottom end 24a and the dent side ends 24b of the dent 24. However, the dent bottom end 25a and the dent side ends 25b of the dent 25 and the dent bottom end 24a and the dent side ends 24b of the dent 24 do not necessarily need to have the same shape or the same size.

The cores 21 and 22 are not limited as long as they are made of magnetic material. For example, the cores 21 and 22 are made of ferrite, a metal magnetic material, or a resin containing magnetic powder. In the present embodiment, the tip of the middle leg portion 21c shown in FIG. 6 and the tip of the middle leg portion 22c shown in FIG. 2A are butted to form a winding core portion, and the tips of the side leg portions 21b and the tips of the side leg portions 22b are butted in contact with each other. In another embodiment, however, the tip of the middle leg portion 21c may not be in direct contact with the tip of the middle leg portion 22c, and a gap may be formed therebetween. A heat dissipating resin 63 shown in FIG. 1B may be inserted into the gap, or another member may be interposed in the gap.

As shown in FIG. 2A, the two cores 21 and 22 may be integrated with an adhesive after the coil body 3 is attached therebetween. Instead, the two cores 21 and 22 may be integrated with a fixing tape, etc. or may be integrated by a combination of them. The adhesive may be a resin material with good thermal conductivity, such as thermal grease.

In the present embodiment, the coil body 3 is a wire winding portion around which a plurality of wires 31 to 34 is wound. In the embodiment, for example, the winding portion of the wire 32 is disposed around the winding portion of the wire 31, the winding portion of the wire 33 is disposed around the winding portion of the wire 32, and the winding portion of the wire 34 is disposed around the winding portion of the wire 33. For example, the wire 31 includes a pair of leading portions 31a and 31b led out from the winding portion of the wire 31, the wire 32 includes a pair of leading portions 32a and 32b led out from the winding portion of the wire 32, the wire 33 includes a pair of leading portions 33a and 33b led out from the winding portion of the wire 33, and the wire 34 includes a pair of leading portions 34a and 34b led out from the winding portion of the wire 34.

In the present embodiment, each of the wires 31 to 34 is made of, for example, a self-bonding conductive wire having an insulating layer and a fusion layer, and the type of conductive wire is not limited and is, for example, a conductive core wire such as round wire, rectangular wire, twisted wire, Litz wire, and braided wire. The material of the fusion layer or the insulating layer covering the core wire is not limited and is, for example, polyurethane, polyamideimide, polyimide, or polyester.

Note that, all of the wires 31 to 34 are self-bonding wires in the present embodiment, but at least any of them may be a self-bonding wire, or all of them may be other wires.

The diameters of the wires 31 to 34 may be the same or different and are not limited. For example, the diameters of the wires 31 to 34 may be within a range of 1.0 to 3.0 mm. The wires 31 to 34 may be wound in a coil shape directly around the middle leg portion(s) 21c and/or 22c of at least one of the cores 21 and 22, but it is preferable that the wires 31 to 34 are previously formed as air-core coils and thereafter arranged around the middle leg portions 21c and 22c of the cores 21 and 22.

As shown in FIG. 2A, a plurality of terminals 4a and 4b is attached to the terminal block 5. The terminal block 5 includes two types of terminals 4a and 4b in the present embodiment, but may include one type of terminal or may include three or more types of terminals. In the present embodiment, two pairs of two types of terminals 4a and 4b are attached to both ends of the terminal block 5 along the Y-axis.

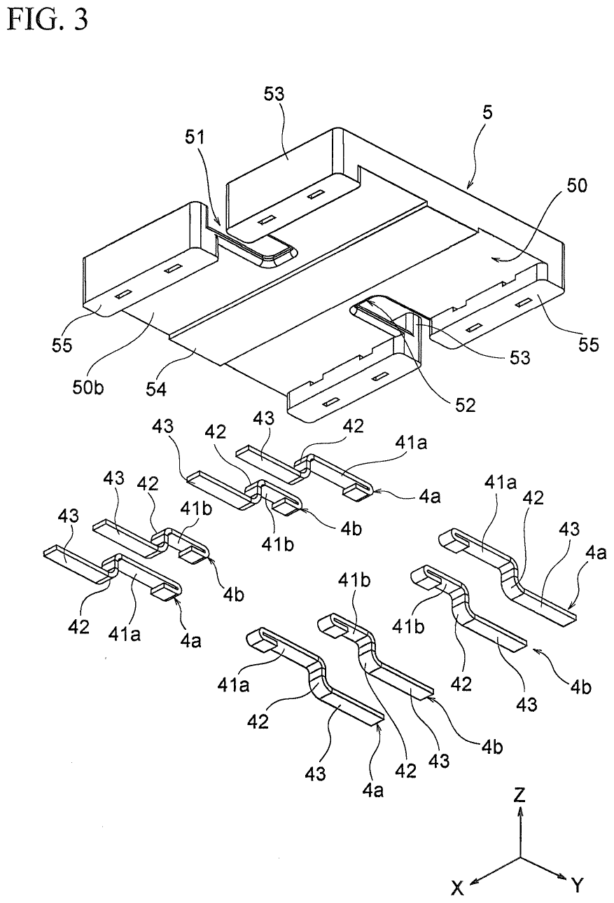

As shown in FIG. 3, each of the terminals 4a includes a wire connection portion 41a, an external connection portion 43, and a joint portion 42 jointing them, and each of the terminals 4b includes a wire connection portion 41b, an external connection portion 43, and a joint portion 42 jointing them. The terminals 4a and 4b have the same configuration, except that the length of each wire connection portion 41a is larger than the length of each wire connection portion 41b. The terminals 4a and 4b can be formed, for example, by pressing a single metal plate.

The plurality of terminals 4a and 4b is attached to the terminal block 5 by insert molding as described below in the present embodiment, but may be attached by being inserted into the terminal block 5 or by adhesive.

In the present embodiment, as shown in FIG. 6, the terminal block 5 includes a base plate 50 including a plane parallel to the X-axis and the Y-axis. The shape of the outer periphery of the base plate 50 is rectangular in accordance with the shape of the outer periphery of the first core 21 (and the second core 22), but may be other shapes, such as polygon, circle, and ellipse.

The base plate 50 includes: a first surface 50a to which the lower surface of the flange portion 21a of the first core 21 along the Z-axis is attached; and a second surface 50b located on the opposite side. The lower surface of the flange portion 21a of the first core 21 along the Z-axis may be fixed to the upper surface of the base plate 50 with an adhesive, etc. or by other means. The first core 21 and the second core 22 may be fixed to each other with an adhesive or by other methods.

The base plate 50 is provided with a first dent 51 and a second dent 52 in accordance with the positions of the dents 24 and 25 of the first core 21. The first dent 51 and the second dent 52 are located on opposite sides of the middle leg portion 21c of the first core 21 along the Y-axis and are each formed so as to be notched from the outer periphery of the base plate 50 toward the center along the Y-axis.

Each of the dents 51 and 52 penetrates the base plate 50 so that the first surface 50a of the base plate 50 on one side along the Z-axis and the second surface 50b of the base plate 50 on the other side along the Z-axis are communicated with each other. Each of the dents 51 and 52 is communicated by being aligned with each of the dents 24 and 25, respectively, and forms a base-side passage for passing the leading portions 31a to 34a and 31b to 34b of the wires 31 to 34 shown in FIG. 2A.

As shown in FIG. 6, a depth D2 along the Y-axis from the opening end to the dent bottom end 51a of the dent 51 is preferably approximately equal to a depth D1 of the first dent 24 of the first core 21, but may be larger than the depth D1 of the first dent 24 of the first core 21. Preferably, however, the dents 51 and 52 are not communicated with each other. The distance between a pair of dent side ends 51b of the dent 51, namely, a width W2 along the X axis of the dent 51 is preferably approximately equal to, for example, the width W1 of the dent 24 of the first core 21, but may be larger than the width W1 of the dent 24 of the first core 21. The width W2 and the depth D2 of the dent 51 are determined so that the wires 31 to 34 passing through the dent 51 can easily enter the dent 51.

Note that, the shape of the dent bottom end 51a is a flat surface in the present embodiment, but is not limited to it and may be a curved surface. The dent bottom end 51a and the dent side ends 51b are continuous to each other. Preferably, the corner edges where the ends 51a and 51b intersects with the first surface 50a or the second surface 50b of the base plate 50 are processed into curved or tapered surfaces. In this configuration, even if the leading portions 31a, 31b, 33a, and 33b of the wires 31 and 33 passing through the dent 51 come into contact with the dent bottom end 51a or the dent side ends 51b, it is possible to minimize the damage to the wires 31 and 33.

The shape and size of the dent bottom end 52a and the dent side ends 52b of the dent 52 are determined in the same manner as those of the dent bottom end 51a and the dent side ends 51b of the dent 51 and are preferably the same as those of the dent bottom end 51a and the dent side ends 51b of the dent 51. However, the dent bottom end 52a and the dent side ends 52b of the dent 52 and the dent bottom end 51a and the dent side ends 51b of the dent 51 do not necessarily need to have the same shape and may have different sizes.

The outer peripheral edge of the base plate is provided with a frame-shaped protrusion portion 53 protruding upward along the Z-axis from the first surface 50a of the base plate 50 so as to surround at least a part of the first core 21 including the flange portion 21a. In the present embodiment, the frame-shaped protrusion portion 53 is integrally formed with the base plate 50 so as to surround the outer peripheral edge of the first core 21 excluding the dents 24 and 25. The protrusion height of the frame-shaped protrusion portion along the Z-axis is not limited and is, for example, larger than ⅕ of the thickness of the flange portion 21a along the Z-axis and may be approximately equal to or less than the thickness of the flange portion 21a along the Z-axis. The size of the inner peripheral edge of the frame-shaped protrusion portion 53 is determined so that: the flange portion 21a of the first core 21 is accommodated in the frame-shaped protrusion portion 53; and the positions of the dents 24 and 25 of the flange portion 21a can be aligned with the positions of the dents 51 and 52 of the base plate 50, respectively.

As shown in FIG. 3, a reinforcement rib 54 extending along the X-axis is integrally formed with the base plate 50 at a central part of the second surface 50b of the base plate 50 along the Y-axis. The portion where the reinforcement rib 54 is located protrudes from the second surface 50b of the base plate 50 compared to other portions. This increases the plate thickness and the strength of the base plate 50 where the dents 51 and 53 are formed and effectively prevents deformation, such as warping, of the base plate 50.

At both ends of the base plate 50 along the Y-axis, a fixation protrusion portion 55 is integrally formed so as to protrude downward along the Z-axis from the second surface 50b in the portions excluding the dents 51 and 52. Preferably, the protrusion height of the fixation protrusion portion 55 from the second surface 50b is larger than the protrusion height of the reinforcement rib 54. The fixation protrusion portion 55 is separated into four in total along the X-axis by the dents 51 and 52, and a pair of terminals 4a and 4b is fixed to each of the protrusion portions 55.

In reality, the joint portions 42 of the terminals 4a and 4b are integrated so as to be embedded in the fixation portion 55, and as shown in FIG. 1B, the wire connection portions 41a and 41b are located on the second surface 50b side of the base plate 50 from the inside of the fixation portion 55 (the center side along the Y-axis). Also, the external connection portions 43 of the terminals 4a and 4b protrude from the protrusion top of the fixation portion 55 and extend to the outside of the case 6. The external connection portions 43 are connected to external connection terminals, terminal connection portions of a circuit board, or the like

Note that, each of the wire connection portions 41a and 41b protrudes linearly from the fixation portion 55 in the present embodiment, but may protrude in a curved shape. Also, the protrusion tips of the wire connection portions 41a and 41b respectively connected with the leading portions 31a and 31b (or 32a and 32b) and the leading portions 33a and 33b (or 34a and 34b) of the wires led out to the second surface 50b side via the same dent 51 (or 52) face the same side along the Y-axis, but are not limited to such an arrangement.

In the present embodiment, it is sufficient that the terminal block 5 includes at least the base plate 50. Preferably, however, the terminal block 5 includes at least one of the frame-shaped protrusion portion 53, the reinforcement rib 54, and the fixation protrusion portion 55. These are integrally formed with the terminals 4a and 4b by insert molding of insulating resin, etc. Note that, the terminal block 5 including the base plate 50 may be made of an insulating material excluding resin.

In the present embodiment, the leading portions 31a, 31b, 33a, and 33b of the wires 31 and 33 shown in FIG. 2A pass through the first dent 24 of the first core 21 and the first dent 51 of the base plate 50 and, as shown in FIG. 1B, are connected to the tips of the wire connection portions 41a and 41b, respectively, arranged in a contacting state on the second surface 50b or in a non-contacting state over the second surface 50b.

Moreover, the leading portions 32a, 32b, 34a, and 34b of the wires 32 and 34 shown in FIG. 2A pass through the second dent 25 of the first core 21 and the second dent 52 of the base plate 50 and, as shown in FIG. 1B, are connected to the tips of the wire connection portions 41a and 41b, respectively, arranged in a contacting state on the second surface 50b or in a non-contacting state over the second surface 50b.

The method of connecting them is not limited, but is preferably laser welding after caulking them. However, they may be connected by other methods, such as caulking, thermocompression, resistance connection, and solder joint.

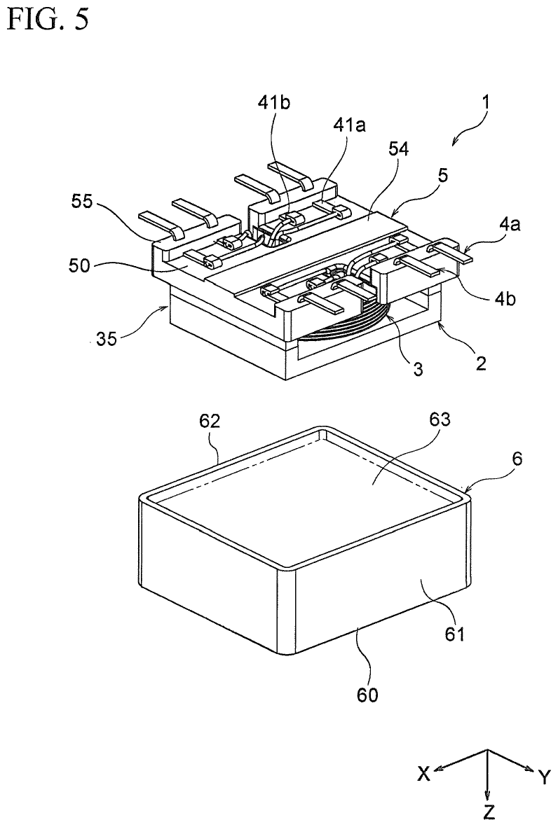

In the present embodiment, as shown in FIG. 5, the core 2 with the coil body 3 attached thereto is fixed to the terminal block 5 including the terminals 4a and 4b, and a coil core assembly 35 in which the terminals 4a and 4b are connected to the leading portions of the coil body 3 is accommodated into the case 6 from the open end of the case 6 filled with the heat dissipating resin 63. Note that, the heat dissipating resin 63 may be filled after the coil core assembly 35 is accommodated into the case 6 from an open end 62. In FIG. 5, the up-down direction (the direction of the arrow in the Z-axis) is reversed from that of the coil device 1 shown in FIG. 1A to FIG. 4 and FIG. 6.

In the present embodiment, the case 6 includes: a substantially rectangular bottom plate 60; and a side plate 61 standing upward along the Z-axis from the four sides of the bottom plate 60 and forming a bottomed accommodation space inside, and an open end 62 is formed at the upper part of FIG. 5 in the Z-axis. The case 6 is preferably made of a metal with excellent thermal conductivity, such as aluminum, but may be made of resin.

Half or more of the coil core assembly 35 is accommodated in the case 6. Preferably, the liquid level (interface with air after hardening) of the heat dissipating resin 63 filled in the case 6 is at a position where at least half or more of the coil body 3 is filled with the heat dissipating resin 63. More preferably, the liquid level of the heat dissipating resin 63 filled in the case 6 is at a position or more where at least the whole of the coil body 3 is filled with the heat dissipating resin 63. Particularly preferably, the wire connection portions 41a and 41b of the terminals 4a and 4b are covered with the heat dissipating resin 63, and the protrusion top surface of the fixation protrusion portion 55 is exposed from the liquid level of the heat dissipating resin 63.

The heat dissipating resin 63 is also referred to as a potting resin and is made of silicone resin, urethane resin, epoxy resin, or the like that remains soft even after injection. Preferably, the potting resin has a longitudinal elastic modulus of 0.1 to 100 MPa. In the present embodiment, for example, the heat generated in the winding portion of the first wire 31, the winding portion of the second wire 32, and the core 2 can be efficiently dissipated to the outside of the case 6 via the heat dissipating resin 63 and the case 6, and the cooling efficiency of the coil device 1 can be improved.

Note that, in the coil body 3 shown in FIG. 2A, if there is a gap between the winding portion of the first wire 31 located on the innermost side and the outer peripheral surface of the middle leg portion 21c or 22c of the core 2, the heat dissipation resin 63 shown in FIG. 5 is interposed in the gap. This improves the heat dissipation performance of the outer peripheral surfaces of the middle leg portions 21b and 22b shown in FIG. 2A and the inner peripheral surface of the winding portion of the coil body 3.

In the coil device 1 according to the present embodiment, as shown in FIG. 2A, the base plate 50 is provided with the dent 51 or 52 as a base-side passage for passing and guiding at least some of the leading portions 31a to 34a and 31b to 34b of the wires 31 to 34 from the coil body 3 to the wire connection portions 41a and 41b. Thus, the leading portions 31a to 34a and 31b to 34b of the wires 31 to 34 are less likely to be in contact with the outer peripheral edge of the base plate 50. As a result, the insulating coating of the leading portions 31a to 34a or 31b to 34b of the wires 31 to 34 is less likely to be damaged, and it is possible to effectively prevent insulation failure and breakage of the leading portions 31a to 34a or 31b to 34b of the wires 31 to 34. Thus, the reliability of the coil device 1 is improved.

In the present embodiment, the dent 51 or 52 as a base-side passage formed in the base plate 50 is a notched dent penetrating the first surface 50a and the second surface 50b. In this configuration, when the leading portions 31a to 34a or 31b to 34b of the wires 31 to 34 are guided to the base plate 50 by penetrating it via the notched dent 51 or 52, the leading portions 31a to 34a or 31b to 34b of the wires 31 to 34 are less likely to be in contact with the outer peripheral edge of the base plate 50.

Moreover, since the leading portions 31a to 34a or 31b to 34b of the multiple wires 31 to 34 can be guided via the dents 51 and 52 of the base plate 50, the leading portions are led out without interfering with the winding of the wires, the wires are wound densely, and the occupancy rate of the wires is improved. Also, since the multiple wires 31 to 34 are easily wound in an overlapping manner in the radial direction, the low profile of the coil device is achieved.

In the present embodiment, as shown in FIG. 6, the dent peripheral edges (inner peripheral edges) 51a and 52a of the dents 51 and 52 as the base-side passages extend close to the middle leg portion 21c as the winding core portion. In this configuration, when the leading portions 31a to 34a and 31b to 34b of the wires are guided from the coil body 3 shown in FIG. 2A arranged around the middle leg portion 21c to the wire connection portions 41a and 41b located on the second surface 50b of the base plate 50, the leading portions 31a to 34a and 31b to 34b of the wires are more unlikely to be in contact with the outer peripheral edge of the base plate 50.

In the present embodiment, as shown in FIG. 6, the core 2 includes the flange portion 21a magnetically coupled to the middle leg portion 21c. The flange portion 21a is disposed on the base plate 50 and includes the dents 24 and 25 communicated with the dents 51 and 52. In this configuration, the leading portions 31a to 34a and 31b to 34b of the wires can be guided from the coil body 3 disposed around the middle leg portion 21c to the wire connection portions 41a and 41b located on the second surface 50b of the base plate 50 after sequentially passing through the dents 24 and 25 communicated with the dents 51 and 52.

Thus, the leading portions 31a to 34a and 31b to 34b of the wires are more unlikely to be in contact with the outer peripheral edge of the base plate 50 and are also unlikely to be in contact with the outer peripheral edge of the flange portion 21a of the core. As a result, the insulating coating of the leading portions 31a to 34a and 31b to 34b of the wires is more unlikely to be damaged, and it is possible to more effectively prevent insulation failure and breakage of the leading portions 31a to 34a and 31b to 34b of the wires. Thus, the reliability of the coil device 1 is further improved.

The base plate 50 includes the frame-shaped protrusion portion 53 protruding from the first surface 50a of the base plate 50 so as to surround at least a part of the core 2 including the flange portion 21a. The protrusion portion 53 can determine the position of the core 2 with respect to the base plate 50 and can improve the insulation between the core 2 disposed on the first surface 50a and the wire connection portions 41a and 41b of the terminals 4a and 4b arranged on the second surface 50b.

Moreover, at least one and the other of the pair of dents 24 and 25 as core-side passages are located opposite to each other in the Y-axis around the middle leg portion 21c. In this configuration, for example, it is possible to pass the leading portion of the wire constituting a primary coil through one of the pair of dents 24 and 25 and the leading portion of the wire constituting a secondary coil through the other of the pair of dents 24 and 25, and the terminals to which the leading portions of wires requiring a high degree of insulation are connected can easily be positioned opposite to each other around the core.

As shown in FIG. 5, the coil device 1 further includes the case 6 for accommodating the coil core assembly 35 including the core 2 and the coil body 3 so as to cover at least the coil body 3. The heat dissipating resin 63 is filled in the case 6 up to a position where at least a part of the coil body 3 is immersed.

Since the heat dissipating resin 63 is filled, the coil device 1 can be cooled effectively by efficiently transferring the heat generated in the middle leg portions 21c and 22c of the core 2 and the coil body 3 via the heat dissipating resin 63. Also, the coil body 3 and the core 2 can be effectively protected by the heat dissipating resin 63 and the case 6. If the case 6 is made of metal, the heat dissipation characteristics are further improved, but the case 6 may be made of resin (preferably, a resin with excellent heat dissipation characteristics). In this case, the insulation characteristics are improved.

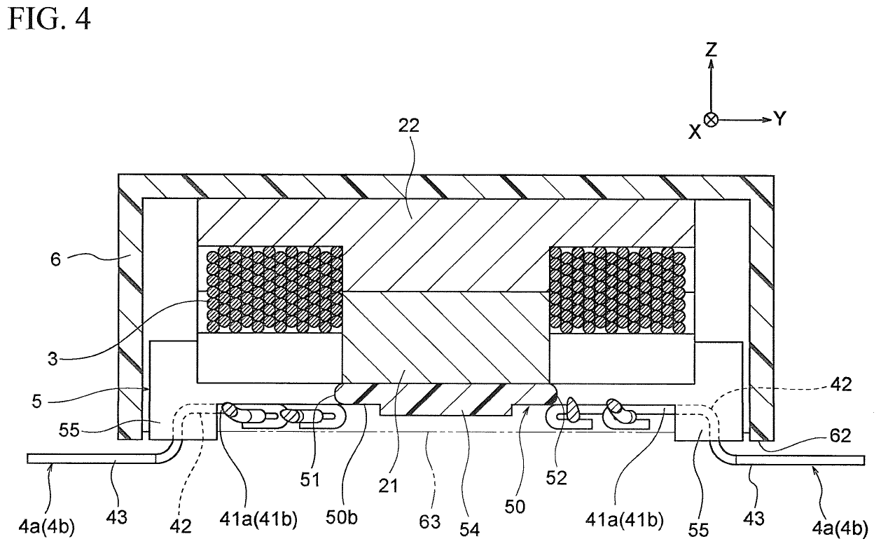

Preferably, as shown in FIG. 4, the heat dissipating resin 63 is filled in the case 6 so as to cover the wire connection portions 41a and 41b of the terminals arranged on the second surface 50b of the base plate 50. In this configuration, the wire connection portions 41a and 41b are covered with the heat dissipating resin 63 and can thus be effectively protected.

The terminal 4a (4b) includes the wire connection portion 41a (41b), the joint portion 42 having the wire connection portion formed at one end, and the external connection portion 43 formed at the other end of the joint portion 42. The joint portions 42 are fixed to the fixation protrusion portion 55 formed so as to protrude from the second surface 50b of the base plate 50, and the top of the fixation protrusion portion 55 and the external connection portions 43 of the terminals 4a and 4b protrude from the heat dissipating resin 63. Since the external connection portions 43 of the terminals 4a and 4b protrude from the heat dissipating resin 63, the coil device 1 is mounted easily.

### Second Embodiment

A coil device 1A of the present embodiment shown in FIG. 2B has configurations and effects similar to those of the coil device 1 of the above-described embodiment, except that the configuration of a core 2A is different from that of the core 2 of the coil device 1 of the above-described embodiment.

In the embodiment shown in FIG. 2B, the core 2A is formed by combining a first core 21A, a second core 22A, and a pair of side leg portions 22b1, and the configuration of the final core after the combination is similar to that of the core 2.

In the present embodiment, the two middle leg portions 21c and 22c of the core 2 in the above-described embodiment are integrated to form a middle leg portion 22c1, and the middle leg portion 22c 1 is integrated with a flange portion 22a. Also, the pair of side leg portions 21b and the pair of side leg portions 22b of the core 2 in the above-described embodiment are integrated to form side leg portions 22b1, and the side leg portions 22b1 are formed separately from the flange portion 21a and the flange portion 22a and joined to both ends of the flange portion 21a and the flange portion 22a along the X-axis.

The present invention is not limited to the above-described embodiments and may variously be modified within the scope of the present invention.

In the above-described embodiments, for example, as shown in FIG. 6, the dents 51 and 52 having a substantially rectangular shape when viewed from the Z-axis direction are formed on both sides of the base plate 50 along the Y-axis. However, the dents 51 and 52 may have a shape other than a substantially rectangular shape, such as triangle, polygon, partial circle, and partial ellipse. The base plate 50 may be provided with only one of the dents 51 and 52 or may be provided with three or more dents. Instead of the notched dent 51 or 52, a hole penetrating the first surface 50a and the second surface 50b of the base plate 50 may serve as a base-side passage.

The dent 24 or 25 formed in the flange portion 21a is substantially rectangular when viewed from the Z-axis direction in accordance with the shape of the dent 51 or 52, but may have a shape other than a substantially rectangular shape, such as triangle, polygon, partial circle, and partial ellipse. Also, the flange portion 21a may be provided with only one of the dents 24 and 25 or may be provided with three or more dents. Also, instead of the notched dent 24 or 25, a through hole may serve as a core-side passage.

Note that, the size of the dent 24 (25) is preferably substantially equal to the size of the dent 51 (52), but is not necessarily equal to the size of the dent 51 (52), and the width W1 of the dent 24 (25) may be different from the width W2 of the dent 51 (52). For example, the width W1 of the dent 24 (25) may be larger than the width W2 of the dent 51 (52), and vice versa. For example, when the width W1 of the dent 24 (25) is larger than the width W2 of the dent 51 (52), it is possible to effectively prevent the leading portions of the wires from strongly coming into contact with the edges of the dent side ends 24b and 25b of the dents 24 and 25.

The depth D1 of the dent 24 (25) is preferably substantially equal to the depth D2 of the dent 51 (52), but may be different from the depth D2 of the dent 51 (52). For example, the depth D1 of the dent 24 (25) may be larger than the depth D2 of the dent 51 (52), or vice versa. For example, when the depth D1 of the dent 24 (25) is larger than the depth D2 of the dent 51 (52), it is possible to effectively prevent the leading portions of the wires from strongly coming into contact with the edges of the dent bottom ends 24a and 25a of the dents 24 and 25.

### DESCRIPTION OF THE REFERENCE NUMERICAL

1, 1A . . . coil device
2, 2A . . . core
21, 21A . . . first core
21a . . . flange portion
21b . . . side leg portion
21c . . . middle leg portion (winding core portion)
21c1 . . . middle leg portion (winding core portion)
22, 22A . . . second core
22a . . . flange portion
22b, 22b1 . . . side leg portion
22c . . . middle leg portion (winding core portion)
24 . . . first dent (core-side passage)
24a . . . dent bottom end
24b . . . dent side end
25 . . . second dent (core-side passage)
25a . . . dent bottom end
25b . . . dent side end
3 . . . coil body (wire-winding portion)
31-34 . . . wire
31a-34a, 31b-34b . . . leading portion
35 . . . coil core assembly
4a, 4b . . . terminal
41a, 41b . . . wire connection portion
42 . . . joint portion
43 . . . external connection portion
5 . . . terminal block
50 . . . base plate
50a . . . first surface
50b . . . second surface
51 . . . first dent (base-side passage)
51a . . . first dent bottom end
51b . . . first dent side end
52 . . . second dent (base-side passage)
52a . . . second dent bottom end
52b . . . second dent side end
53 . . . frame-shaped protrusion portion
54 . . . reinforcement rib
55 . . . fixation protrusion portion
6 . . . case
60 . . . bottom plate
61 . . . side plate
62 . . . open end
63 . . . heat dissipating resin

What is claimed is:

1. A coil device comprising:
a core including a winding core portion;
a winding portion of a wire disposed in a coil shape around the winding core portion; and
a base plate provided with a terminal to which a leading portion of the wire led out from the winding portion is attached,
wherein
the core is disposed on a first surface as one surface of the base plate,
a wire connection portion of the terminal is disposed on a second surface as the other surface of the base plate located opposite to the first surface, and
the base plate is provided with a base-side passage for passing and guiding the leading portion of the wire from the winding portion to the wire connection portion.

2. The coil device according to claim 1, wherein the base-side passage comprises a notched dent or a through hole penetrating the first surface and the second surface.

3. The coil device according to claim 1, wherein an inner peripheral edge of the base-side passage extends close to the winding core portion.

4. The coil device according to claim 1, wherein
the core includes a flange portion magnetically coupled to the winding core portion, and
the flange portion is disposed on the base plate and includes a core-side passage communicated with the base-side passage.

5. The coil device according to claim 4, wherein the base plate includes a protrusion portion protruding from the first surface of the base plate so as to surround at least a part of the core including the flange portion.

6. The coil device according to claim 4, wherein
the core-side passage includes at least a pair of core-side passages, and
one and the other of the pair of core-side passages are located opposite to each other around the winding core portion.

7. The coil device according to claim 1, further comprising a case for accommodating the core and the winding portion of the wire so as to cover at least the winding portion of the wire disposed around the winding core portion,
wherein a heat dissipating resin is filled in the case up to a position where at least a part of the winding portion of the wire is immersed.

8. The coil device according to claim 7, wherein the heat dissipating resin is filled in the case so as to cover the wire connection portion of the terminal disposed on the second surface of the base plate.

9. The coil device according to claim 8, wherein
the terminal includes:
a joint portion provided with the wire connection portion at one end; and
an external connection portion formed at the other end of the joint portion,
the joint portion is fixed to a fixation protrusion portion formed to protrude from the second surface of the base plate, and
a top of the fixation protrusion portion and the external connection portion of the terminal protrude from the heat dissipating resin.
